(19) United States
(12) Patent Application Publication
(10) Pub. No.: US 2012/0264669 A1
(43) Pub. Date: Oct. 18, 2012

(54) COMBINATION OF POLYMER AND SURFACTANT FOR IMPROVED LAUNDRY

(75) Inventors: Galder Cristobal, Shanghai (CN); Weizhong Edric Tan, Shanghai (CN); Pascal Metivier, Shanghai (CN); Rongjun Lu, Shanghai (CN); Florence Lambert, Aubervillers (FR)

(73) Assignee: Rhodia (China) Co., Ltd., Shanghai (CN)

(21) Appl. No.: 13/518,665

(22) PCT Filed: Dec. 31, 2009
(86) PCT No.: PCT/CN2009/076345

§ 371 Date: Jun. 22, 2012

(51) Int. Cl. C11D 3/37

(52) U.S. Cl. 510/299; 510/528

(57) ABSTRACT

A polyester soil-release polymer (a) and a cosurfactant (b) are used in a laundry composition to improve primary detergency, secondary detergency, and/or soil anti-redeposition and/or to allow a reduction of the amount of surfactant(s) and/or builder(s). Also disclosed is a performance additive comprising at least 20% by weight as actives, of a mixture of (a), (b) and optionally water or other products, in an amount by weight if present of lower than 80%, and the performance additive is mixed with other ingredients to make a laundry composition.

### FIELD OF THE INVENTION

The invention relates to laundry. It relates to the use of a polymer and a surfactant in a laundry composition to improve primary detergency, secondary detergency, and/or soil anti-redeposition. It also relates to use of a polymer and a surfactant in a laundry composition to allow a reduction of the amount of surfactant(s) or and/or of builder(s). The invention also relates to performance additives.

### BACKGROUND OF THE INVENTION

In the process of laundry, wherein textiles are washed with a diluted laundry composition, one uses a certain amount of a laundry composition. Usually the higher the amount is the better to the primary detergency is. Typical amounts and/or dilution rates are usually provided on the packaging of the laundry composition, for standard machines if the laundry composition is indented to be used in automatic laundry machines. There is a need for improved laundry compositions, that provide improved performance (typically primary detergency, secondary detergency, and/or soil anti-redeposition) and/or that provide an equal performance while decreasing the total amount of laundry composition used (typically with the amount provided on the packaging). Such a decrease is good for the environment and/or allows less expensive laundry compositions, or laundry procedures.

Document U.S. Pat. No. 6,242,404 discloses that associations of soil release polymers and some non ionic surfactants or amhoteric/zwitterionic surfactant in some laundry compositions show enhanced soil release performances of the soil release polymers. This document also teaches (col 4 lines 1-4) that soil removal, “general detergency”, and secondary properties prevention of redeposition of soil are enhanced. The document presents examples wherein secondary detergency is tested. There is still a need however for improved primary detergency and/or for solutions that allow decreasing the total amount of laundry composition used.

### BRIEF SUMMARY OF THE INVENTION

The invention addresses at least one of the needs detailed above, with the use in a laundry composition comprising surfactant(s), as agents improving primary detergency, secondary detergency, and/or soil anti-redeposition and/or a as agent allowing a reduction of the amount of surfactant(s) and/or of builder(s), of a performance association of the following compounds:

a) a polyester soil-release polymer, and
b) a cosurfactant.

The invention also relates to a performance additive comprising:

at least 20% by weight as actives, preferably at least 30%, preferably at least 50%, preferably at least 75%, preferably a least 90%, of a mixture of the following compounds:

a) a polyester soil-release polymer
b) a cosurfactant, and

optionally water or other products, in a amount by weight if present of lower than 80%, preferably of lower than 70%, preferably of lower than 50%.

The invention also relates to a process of making a laundry composition, comprising the step of mixing the performance additive.

The invention also relates to a process washing textiles (laundry) involving diluting the laundry composition. This process can be carried out in a domestic private context, or in an industrial, institutional or service context. The textiles concerned are typically finished clothes.

### DETAILED DESCRIPTION OF THE INVENTION

### Definitions

In the present application primary detergency is the detergency performance measured after a first washing involving a certain laundry composition. Some laundry composition can deposit on textiles some compounds that will improve the detergency at next washing. Such a performance at next washing is considered as a secondary detergency. Primary detergency can be considered as the result of a detergency test in which different textile swatches, preferably 6 swatches but occasionally 3 are washed in a container of a preferred volume of 1 L, with a detergent formulation to be tested. The swatches are PolyEster type, Cotton type or Cotton/PolyEster type with a repartition of 50/50. Prior to the primary detergency test, the swatches have been stained and dried in an oven for at least 1 hour and later put into the container in which previously the detergent formulation has been dissolved. In some cases the swatches have been bought and are already stained prior to the detergency test. The detergent formulation is made of a typical powder detergent formulation to which an additive might have been introduced prior to the detergency test. The concentration of the additive in respect to the detergent is around 1.25% but might vary within a range of 5 to 1 wt %. The detergent concentration in the wash is 2 g/L but might vary between 1 g/L and 3 g/L.

In the present application a cosurfactant refers to a surfactant that is a minor in the composition, and that preferably has an effect on primary detergency when combined with the polymer. Cosurfactants are typically present in the laundry composition in an amount by less than 20% by weight, preferably of less than 10%, for example from 1% to 5% or from more than 5% to 10%, of the main surfactant(s) of the laundry composition. It is mentioned that the co-surfactant can be a mixture of several surfactants.

In the present application, a performance association refers to the association of compound a) and compound b) in the laundry composition. These can be introduced in the laundry composition separately, optionally at various steps of the process of preparing the composition or as a performance additive. In the present application a performance additive refers to a mixture comprising (or preferably consisting of compound a) and compound b) and optionally water, at a high concentration (much higher than in a typical laundry product) intended to be formulated in a laundry composition. A performance additive is a premix of compound a) and compound b) and optionally water. In the present application the performance additive is also referred to as a “blend”

### Compound a) Polyester Soil-Release Polymer

Polyester soil-release polymers (hereafter referred to as “SRPs”) are products that are known by the one skilled in art and that are commercially available. SRPs are polyester polymers. There are usually indeed copolymers as they usually comprise several types of repeating units. SRPs are polycondensates of diacids with alcohols, typically diols to form repeating ester linkages. One can use the class of non ionic SRPs or the class of anionic SRPs.

SRPs can be in the form of solids (for example powders or pellets), pastes or liquids. One can use any of these forms.

If the laundry composition is solid, one usually prefers using SRPs in solid form.

If the laundry composition is liquid, one usually prefers using SRPs in liquid form.

SRPs usually comprise:

groups corresponding to diacids (or precursors thereof such as methyl esters of acyl chlorides thereof), preferably of aromatic diacids

groups corresponding to diols,

optionally end groups, corresponding usually to monoacids or mono-alcohols.

The natures, relative amounts of the above mentioned groups, as well as the molecular weight of the (co)polymer are preferably such that the SRP is water-soluble or water-dispersible, in neutral environment and/or in alkaline environment.

The groups corresponding to diacids can be for example groups corresponding to terephtalic acid, isophtalic acid and/or sulfoisophtalic acid. These groups comprise preferably at least 50% by number of groups corresponding to terephtalic acid, and optionally at most 50% by number of other groups such as groups corresponding to isophatlic acid, sulfoisophtalic acid, or groups corresponding to other aromatic or non aromatic optionally substituted groups.

The groups corresponding to diols can be for example groups corresponding to ethylene glycol and/or propylene glycol. The diols (whole or a part) can be condensed as polyether such as polyethylene glycol, polypropylene glycol or polyethylene/polypropylene oligomers (including dimers or trimers) or polymers.

The groups corresponding to end groups can be for example groups corresponding to monoacids (or precursors thereof such as methyl esters of acyl chlorides thereof) or to monoalcohols.

It is mentioned that SRPs usually present more groups corresponding to diols than groups corresponding to diacids. The excess of groups corresponding to diols are usually present is polyether condensed form. The mole ratio between groups corresponding to diols and groups corresponding to diacids can be for example of at least 1.5/1, or of at least 2/1, or of at least 4/1.

Examples of useful SRPs include the polyesters exemplified in U.S. Pat. No. 5,134,223 to Langer, et al.; U.S. Pat. No. 4,999,128 to Sonnenstein; U.S. Pat. Nos. 4,937,277; 4,804,483 and 4,873,003 to O'Lenick, et al.; U.S. Pat. No. 4,861,502 to Caswell; U.S. Pat. No. 4,861,512 to Gosselink; U.S. Pat. No. 4,787,989 to Fanelli, et al.; U.S. Pat. Nos. 3,962,152, 3,416,952, and 4,132,680 to Nicol; U.S. Pat. Nos. 4,201,824, and 4,349,688 to Sandler and U.S. Pat. No. 4,116,885 to Derstadt, et al.

Especially effective SRPs are the block copolymers of polyalkylene terephthalate and polyoxyethylene or terephthalate, and the block copolymers of polyalkylene terephthalate and polyethylene glycol. The polyalkylene terephthalate block copolymers preferably comprise ethylene and/or propylene alkylene groups. Many of such soil release polymers are nonionic. More specifically, these polymers are comprised of repeating units of ethylene and/or propylene terephthalate and polyethylene oxide terephthalate, preferably at a molar ratio of ethylene terephthalate units to polyethylene oxide terephthalate units of from about 25:75 to about 35:65, said polyethylene oxide terephthalate containing polyethylene oxide blocks having molecular weights of from about 300 to about 2000. The molecular weight of these polymeric soil release agents is in the range of from about 4,000 to about 55,000. Other useful soil release polymers include, but are not limited to, sulfonated polyethylene terephthalate, polyester urethane, and acetic acid ethenyl esters; the polyethylene terephthalate/polyoxyethylene terephthalate (PET/POET) polymer being most preferable. Typically, molecular weight ranges of these polymers are from 500 to 120,000, preferably 2000 to 35,000 and most preferably 2000 to 25,000. Most preferred SRPs are non ionic polyethylene terephthalate/polyoxyethylene terephthalate copolyesters.

Another useful SRP is a crystallizable polyester with repeat units of ethylene terephthalate containing from about 10% to about 15% by weight of ethylene terephthalate units together with from about 10% to about 50% by weight of polyoxyethylene terephthalate units, derived from a polyoxyethylene glycol of average molecular weight of from about 300 to about 6,000, and the molar ratio of ethylene terephthalate units to polyoxyethylene terephthalate units in the crystallizable polymeric compound is between 2:1 and 6:1. Examples of this polymer include the commercially available materials Zelcon 4780 (from DuPont) and Milease T (from ICI).

A more complete disclosure useful SRPs is contained in European Patent Application 185,427 to Gosselink, published Jun. 25, 1986.

Particularly useful nonionic SRPs are commercialized by Rhodia as REPEL-O-TEX® line. These products include REPEL-O-TEX® SRP6, REPEL-O-TEX® SRP4, REPEL-O-TEX® QC for example.

Suitable anionic SRPs are disclosed in U.S. Pat. No. 4,018,569 to Trinh, U.S. Pat. No. 4,787,989 to Fanelli, et al.; and U.S. Pat. No. 4,808,086 to Evans et al., all of which are incorporated herein by reference. Particularly useful anionic SRPs are commercialized by Rhodia as REPEL-O-TEX® SF-2 or REPEL-O-TEX® PF594.

According to one embodiment the amount of compound a) in the laundry composition is of lower than 1% by weight, preferably of lower than or equal to 0.5% by weight, preferably of lower than or equal to 0.25% by weight.

### Compound b) Cosurfactant

It is mentioned that the cosurfactant can be a mixture of several cosurfactants.

The cosurfactant is typically a surfactant different from a linear alkylbenzenesulfonate (LAS). The cosurfactant has typically a hydrophobic moiety with a number of carbon atoms of higher than or equal to 12, preferably of higher than or equal to 14. Preferred cosurfactants are non-ionic or amphoteric surfactants, with a number of carbon atoms of higher than or equal to 12, preferably of higher than or equal to 14.

The cosurfactant has preferably a low critical micelle concentration (cmc) and/or can provide a reduction of the critical micelle concentration (cmc) of the laundry composition to very low levels. The cmc is preferably of less than 1.0×10⁻⁵ either by forming mixed micelles and/or by interacting with the anionic surfactants that can be present in the laundry composition. Useful cosurfactants include a number of amphoteric/zwitterionic and long chain nonionic alkoxylate surfactants which can be utilized singly or mixed together in blends. Alkoxylates are typically ethoxylates (“EO” obtained from ethylene oxide) and/or propoxylates (“PO” obtained from propylene oxide), arranged randomly or is a sequenced (or block) fashion.

The long chain nonionic alkoxylate surfactants which have been found to greatly enhance deposition of the soil release polymers onto the fabric include both ethoxylates and ethoxylate/propoxylate compounds. Alkyl phenol ethoxylates (a), ethoxylate propoxylates (b), and di- or tri-styrylphenol alkoxylates are useful in the practice of the present invention and comprise compounds of the structure:

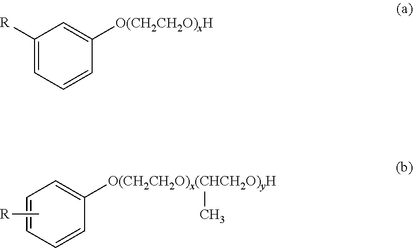

wherein R independently represents a straight or branched chain C₁₄ to C₃₀ alkyl, aryl, alkylene and alkyl aryl. Preferably it is a C₁₄ to C₂₂ linear alkyl, x is a whole integer of from about 1 to 100 and y is an integer from 0 to 50.

Dialkyl phenol ethoxylates also exhibit superior cmc lowering capabilities and comprise compounds of the formula:

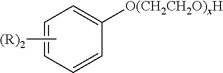

wherein R and x are hereinbefore defined and the two R groups may be the same or different.

Other suitable nonionic alcohol ethoxylates include compounds of the structure:

R—O—(CH₂—CH₂—O)ₓH

wherein R and x have been previously defined.

Long chain alkylamine ethoxylates include compounds of the structure:

RN(CH₂—CH₂—O)_{y}H

wherein R and x have been hereinbefore defined and y independently represents an integer comprising 1 or 2. Similar compounds are alkyl amido amine ethoxylates comprising compounds of the chemical structure:

RC(O)NH[(CH₂—CH₂—O)ₓH]_{y}

wherein R, x and y have all been hereinbefore defined.

Other suitable nonionic surfactants that exhibit low cmc values in the soil release compositions of the present invention include the glycerol and polyglyceryl derivatives of long chain fatty acids. These comprise compounds of the structure:

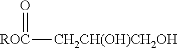

wherein R has been previously defined.

Sorbitan esters and their ethoxylates comprise compounds of the structure:

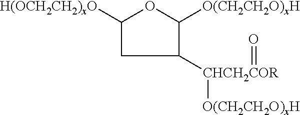

wherein R and x have previously been defined.

Long chain alkanol amides are also suitable for use as the surfactant of the soil release compositions and include compounds of the formula:

R—C(O)N[(CH₂—CH₂—O)ₓH]₂

wherein R has been previously defined and x is 1 or 2. Other useful surfactants comprise the following:
a) Alkyl polyglycosides of the structural formula:

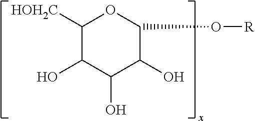

wherein x is a number from about 1 to 4 and R has been previously defined. The useful amphoteric surfactants that provide the cmc lowering functionality are selected from the group consisting of C₁₄ to C₂₂ amine oxides, C₁₂ to C₂₂ alkyl amido betaines, C₁₂-C₂₂ alkyl betaines, C₁₂ to C₂₂ alkylamphoacetates, C₁₂ to C₂₂ alkylamphopropionates, C₁₂ to C₂₂ N-methyl alkyltaurates and mixtures thereof. The hydrophobic chains of each species may also be fluorinated or silicone based. Specifically, the amphoteric surfactants that may be used include the following compounds with their respective structures:
a) Amine oxides
b) Alkyl amphoacetates:
c) Alkyl amphopropionates:
d) Alkyl amidoiminopropionates:
e) Alkyl iminopropionates:
f) Alkyl iminoacetates:
g) Alkyl betaines:
h) Alkyl amidopropyl betaines:
i) Alkyl amidopropyl sultaines:
j) Dihydroxyethyl glycinates:
k) Alkyl etherhydroxypropyl sultaines:

Other useful cosurfactants include gemini surfactants, for example non ionic gemini surfactants or anionic gemini surfactants. Examples include anionic gemini surfactants having two carboxylic moieties (DCG). An example of a useful anionic gemini surfactant is the following compound:

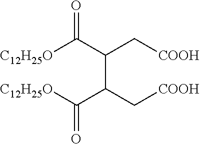

Especially useful compounds b) cosurfactants can be selected from the group consisting of the following:

fatty alcohols polyalkoxylates, with the fatty alcohol being preferably a C₁₄-C₁₈ fatty alcohol and/or with the polyalkoxylate being preferably a C₁₅-C₂₅

terpene alkoxylates, for example ethoxylated and/or propoxylated terpenes,

betaines, preferably alkylbetaines alkylamidoalkyl betaines, preferably an alkylamidopropyl betaine, wherein the alkyl is preferably a C₁₂-C₁₄ alkyl,

sultaines, preferably alkylamidoalkyl sultaines, preferably an alkylamidopropyl sultaine or hydroxysultaine, wherein the alkyl is preferably a C₁₂-C₁₄ alkyl

anionic gemini anionic surfactants, preferably gemini surfactants having two carboxylic moieties.

Examples of commercial products that can be used as cosurfactants according to the invention are the following:

Mirataine® BET C30 (Rhodia)—Cocoamidopropylbetaine

Mirataine® BB/FLA (Rhodia)—coco betaine

Mirataine® CBS (Rhodia)—cocoamidopropyl hydroxysultaine

Brij® 58, Sasol or Chinese Manufacturer (Nanjing)—Ethoxylated alcohol (C₁₋₆ alcohol—20 ethoxylate units)

Antarox® BL 225 (Rhodia)—Linear alcohol EO/PO

Rhodoclean® MSC (Rhodia)—Terpene alkoxylate

Rhodoclean® EFC (Rhodia)—Terpene alkoxylate

Rhodasurf® LA9 (Ethoxylated alcohol C12-9 ethoxylated units)

“DCG”—Dicarboxylic Gemini Surfactant.

According to one embodiment the amount of compound b) in the laundry composition is of lower than 1% by weight, preferably of lower than or equal to 0.5% by weight, preferably of lower than or equal to 0.25% by weight.

### Laundry Composition

Laundry compositions are known by the one skilled in the art. They comprise surfactants, typically anionic surfactants such as Linear Alkylbenzene Sulfonate (LAS) and usually also builders. The laundry compositions of the invention further comprise compounds a) and b) as additives. Compounds different from compounds a) and b) are herein referred to as “other ingredients” or “further ingredients”.

The laundry composition comprises other ingredients, further to the compounds of the performance association. These can be typical ingredients of laundry compositions, known by the one skilled in the art, such as:

anionic surfactants such as Linear Alkylbenzene Sulfonate (LAS)

builders, such polyphosphates, carbonates, polycarboxylates, (meta)silicates, zeolites

perfume,

enzymes,

sequestrants,

optical brighteners,

pH regulators

In one embodiment the laundry composition is a low cost formulation that is mainly formulated with anionic surfactants and does not present any non ionic surfactants nor soil releasing agents, nor enzymes. Typical formulations are for example in Europe formulations having 8-12% by weight of anionic surfactants, and in China 13-17% by weight of anionic surfactants.

According to one embodiment

the amount of compound a) in the laundry composition is of lower than 1% by weight, preferably of lower than or equal to 0.5% by weight, preferably of lower than or equal to 0.25% by weight, and

the amount of compound b) in the laundry composition is of lower than 1% by weight, preferably of lower than or equal to 0.5% by weight, preferably of lower than or equal to 0.25% by weight.

In one particular embodiment the ratio by weight between compound b) and compound a) in the laundry composition is of from 1/10 to 10/1, preferably of from 1/4 to 4/1, preferably of from 1/2 to 2/1.

The laundry composition can be for example in the form of a powder, granules, tablets, or a liquid.

Typical powder formulations for Asian and Western countries are given in the following table (amounts can further vary in the range of 20 or 10% above or below the amounts indicated):

| | Original formula in a | Original formula in a |
|---|---|---|
| | typical Chinese | typical Western |
| Components | Formulation | Formulation |
| LAS | 16.0 wt % | 10 wt % |
| 4A Zeolite | 18.0 wt % | 15% |
| Sodium carbonate | 15.0 wt % | 15 wt % |
| Sodium metasilicate | 8.0 wt % | 10 wt % |
| Polymer | 2.0 wt % | 2.0 wt % |
| (polyacrylates) | | |
| CMC | 1.0 wt % | 1 wt % |
| Sodium sulfate (top | 42.0 wt % | 47 wt % |
| up) | | |

The laundry composition is typically diluted with water during a process of washing.

In one embodiment the laundry composition is diluted with water during a process of washing to a concentration such that the amount of compound a) is of lower than 0.1 g/L, preferably of lower than 0.02 g/L, preferably of lower than 0.01 g/L, preferably of lower than or equal to 0.005 g/L.

### Process of Preparing the Laundry Composition

The laundry composition is typically prepared by mixing its ingredients. The compounds of the performance association can be introduced in the laundry composition in different ways, for example separately or as a performance additive.

As any other additive that is introduced in a power of granules or tablet laundry formulation, the compounds of the performance association can be added during the slurry phase prior to the atomization, or in post-addition in form of powder that is mixed to the detergent powder or granule or tablet.

The additives (compounds a) and b)) that are described in this document can be introduced either way; either they are separately added in the slurry, either they are added separately in the post-addition. Preferably, as some of the soil release polymers have a waxy character at room temperature and are not easy to make into powder, the slurry route will be chosen.

In addition to a separate addition of the additives, a more interesting route of formulation consists of blending the additives either in powder or in liquid form to provide a performance additive. Further details about performance additives are given below. In one embodiment mixing of the performance additive is performed during or after mixing other ingredients.

In one particular embodiment the process of preparing the laundry composition is a process, wherein:

the laundry composition is in a powder form,

the performance additive is in a powder form, and

mixing of the performance additive is performed after mixing other ingredients.

In one particular embodiment the process of preparing the laundry composition is a process, wherein:

the laundry composition is in a powder form,

the performance additive is in a liquid form, and

mixing of the performance additive is performed before obtaining the powder form, preferably at a slurry stage before atomization.

The soil release polymers and the cosurfactant can be intimately blended together at different SRP/cosurfactant ratios, and in the liquid blend scenario, the blend can be processed at different active concentrations. The blending of the soil release polymer with the cosurfactant brings a processing advantage for the end user as these two additives can be incorporated as a single component. Furthermore, from the performance point of view, the prior blending of the surfactant and the polymer gives superior performances to the blend because the soil release polymer is more soluble in water and this gives extra primary detergency to the system.

According to one embodiment from 0.1 to 10, preferably from 0.5 to 2 parts as solids of performance additive are mixed with from 80 to 100 parts of other ingredients.

### Performance Additive

The performance additive can be in a solid form or in a liquid form. When the performance additive is in a liquid form, the amount of actives (compound a) and b)) is preferably of from 20% to 90% by weight, preferably of from 30 to 40%. According to a preferred embodiment the ratio by weight between compound b) and compound a) in the performance additive is of from 1/10 to 10/1, preferably of from 1/4 to 4/1, preferably of from 1/2 to 2/1.

The performance additive can be a liquid or solid blend made of a soil release polymer and a cosurfactant can be formulated at from 50/50 active (50 wt % SRP, 50 wt % cosurfactant) to up to 25/75 active (25 wt % SRP, 75 wt % cosurfactant). The blending can be performed as follows: First the cosurfactant is introduced in a vessel. If the cosurfactant is in liquid form the soil release polymer can be incorporated immediately and then the whole is agitated until the mixture is homogeneous. Depending on the active concentration of the final liquid mixture, additional water can be introduced in order to make the mixture flowable. In the case of the cosurfactant and the soil release polymers being solid at room temperature, the temperature of the vessel has to be raised in order to melt the cosurfactant. Once the cosurfactant is in liquid form, the soil release polymer can be incorporated at high temperature. Additional water can be added if the final sample is aimed to be liquid, or leave the mixture as is if the aim is to obtain a solid sample. In this particular case, the mixture will be introduced in a special device in order to make pellets of the two components or to obtain powder from them. In the case of a final liquid blend, the system is cooled down to room temperature and a flowable liquid containing both additives is obtained. It is possible to formulate liquid blends at active concentrations ranging from 20 wt % to 70 wt %. Ideally one can work with cosurfactant/soil release polymer ratios of 50/50 at active concentrations within the 30-40 wt % range.

### Process to Use of the Laundry Composition

The laundry composition can be used according to standard procedures that are known by the one skilled in the art as well as by the final user. Accordingly it can be used according to hand-washing procedure, according to procedure involving an automatic or semi automatic cleaning (with automatic machines or semi automatic machines). Then the laundry can be dried, optionally with using a dryer. Standard procedures usually involve, during the process of washing, diluting the laundry composition to provide a diluted main wash solution. The dilution can be typically of from 0.5 g/L to 5 g/L, preferably of from 1 g/L to 2 g/L. The dilution is preferably operated to a concentration such that the amount of compound a) is of lower than 0.02 g/L, preferably of lower than or equal to 0.005 g/L.

As the final user usually does not know exactly the concentrations of the various ingredients of the laundry composition, the concentrations can be achieved by operating instructions provided on the packaging of the laundry composition, optionally associated with dosage means (such as recipients, balls, cups, sachets etc).

Further details or advantages of the present invention can be found in the non-limitative examples below.

### EXAMPLES

The following products are used in the following examples:

Commercial Laundry detergents used:

NICER: commercial detergent available in China (powder detergent), Generic Phosphate-free formula marketed by NICE inc.

LIBY®: commercial detergent available in China (powder detergent). Generic Phosphate-free formula marketed by LIBY inc.

FAB® (Ocean Breeze): commercial detergent available in the USA (Phosphate-free powder detergent)

X-TRA® (Total): commercial detergent available in Europe (Phosphate-free powder detergent), marketed by Henkel

YPE® (Premium Ecologico): commercial detergent available in Brazil (Phosphate-free powder detergent)

BLANC-O2® (Branco Fascinante, Alta perfumacao): commercial detergent available in Brazil (Phosphate-free powder detergent)

Soil Release Polymer:

“ROT6”: RepelOTex® SRP 6, Rhodia

“ROT QC” pellets: RepelOTex® QC, Rhodia, dried to a solid content of 30% by weight

“ROT SF2”: RepelOTex® SF2, Rhodia

Cosurfactant:

“BET C30”: Mirataine® BET C30 (Rhodia, Cocoamidopropylbetaine)

“BRIJ” Brij® 58, Sasol or Chinese Manufacturer (Nanjing)—Ethoxylated alcohol (C₁₆ alcohol—20 ethoxylate units)

Rhodasurf LA9: Rhodasurf® LA9 (Rhodia)—Ethoxylated alcohol (C₁₂ alcohol—9 ethoxylate units)

“DCG”—Dicarboxylic Gemini Surfactant of formula

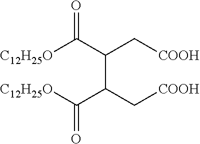

Blends (performance additive):
DVAP-09-QB01: Liquid blend where Brij and ROT QC pellets are jointly mixed and processed. The active ratio of Brij and ROT QC is 50/50, which means equal amount of the cosurfactant and the soil release polymer. Furthermore the total active concentration in the blend is of 35 wt %
DVAP-09-QB02: Liquid blend where Brij and ROT QC pellets are jointly mixed and processed. The active ratio of Brij and ROT QC is 75/25, which means 3 parts of cosurfactant for one part of soil release polymer. Furthermore the total active concentration in the blend is of 35 wt %
DVAP-08-6B01: Solid blend where Brij and ROT SRP6 are jointly mixed and processed. The active ratio of Brij and ROT SRP6 is 50/50, which means equal amount of the cosurfactant and the soil release polymer.
DVAP-08-6B02: Solid blend where Brij and ROT SRP6 are jointly mixed and processed. The active ratio of Brij and ROT SRP6 is 75/25 which means 3 parts of cosurfactant for one part of soil release polymer.
DVAP-08-6C01: Solid blend where BetC30 and ROT SRP6 are jointly mixed and processed. The active ratio of BetC30 and ROT SRP6 is 50/50, which means equal amount of the cosurfactant and the soil release polymer.
DVAP-08-6C02: Solid blend where BetC30 and ROT SRP6 are jointly mixed and processed. The active ratio of BetC30 and ROT SRP6 is 75/25 which means 3 parts of cosurfactant for one part of soil release polymer.
DVAP-08-2C01: Solid blend where BetC30 and ROT SF2 are jointly mixed and processed. The active ratio of BetC30 and ROT SF2 is 50/50, which means equal amount of the cosurfactant and the soil release polymer.
DVAP-08-2C02: Solid blend where BetC30 and ROT SF2 are jointly mixed and processed. The active ratio of BetC30 and ROT SF2 is 75/25 which means 3 parts of cosurfactant for one part of soil release polymer.
DVAP-08-6DG01: Solid blend where DCG and ROT SRP6 are jointly mixed and processed. The active ratio of DCG and ROT SRP6 is 50/50, which means equal amount of the cosurfactant and the soil release polymer.
DVAP-08-6DG2: Solid blend where Dicarboxylic Gemini surfactant and ROT SRP6 are jointly mixed and processed. The active ratio of DCG and ROT SRP6 is 75/25 which means 3 parts of cosurfactant for one part of soil release polymer.

Tests on primary detergency are carried out by measuring the amount of stain removed from regulated Chinese prestained soil cloths (“swatch”), provided by the institute of Chinese dayl)—chemicals.

JB01—Cotton with Carbon Black/Oil Dirt

JB02—Cotton with Protein

JB03—Cotton with Sebum

Tests are also carried out with European prestained soil cloths (“swatch”), provided by WFK (Germany).

LWFK—Cotton lipstick

CS-61—Cotton with beef lard

20C—Cotton/PolyEster (35/65) with Pigment/Lanolin

20D—Cotton/Polyester (35/65) with Pigment/Sebum

BMI—Cotton with blood, milk and ink

In addition, tests are also carried out on further stained cloths:

VDC—Cotton with Violet Dye in Soy Oil

DMOC—Cotton with Dirty Motor Oil

LMC—Cotton with Lipstick in mineral oil

CC—Cotton with Curry sauce

VDPE—PolyEster with Violet Dye in Soy Oil

DMOPE—PolyEster with Dirty Motor Oil

VDCPE—Cotton/PolyEster (50/50) with Violet Dye in Soy Oil

DMOCPE—Cotton/PolyEster (50/50) with Dirty Motor Oil

The tests involve using various dosage of a laundry product with further additives (Soil Release Polymer and/or Cosurfactant) that can be introduced separately or in the form of a blend. In some cases, when the dosage of the laundry product is reduced by 20% to 40% and the amount of soil release polymer and/or cosurfactant is not enough to recover the “original” dosage (“original” meaning the recommended dosage of the detergent manufacturer) classical fillers as sulphate, carbonate or zeolites can be introduced in order to bring the system to its original dosage level. The additives, are added separately or as blends, after dilution of the laundry product to dosage (the additives are introduce in the washing solution).
“Main wash”)

Wash tests are carried out with a Launderometer (SDL Atlas, AATCC) or with a Tergotometer (Hoboken, N.J.), with the tests conditions are summarized in the following table:

Water hardness 250 ppm

Calcium to Magnesium ratio 6:4

Water Temperature 30° C.

Recommended dosage of laundry detergent 2 g/L Washing time 60 min (Launderometer) 20 min (Tergometer)

Number of swatches per pot At least 3.

When the launderometer is used for the experiments one mixes swatches with different stains. The mixtures are made by group as when the “JB” swatches are studied the three prestained JB swatches are mixed together. When the WFK swatches are studied, the 4 prestained swatches are mixed together. When the home made stains are studied, the 3 swatches are mixed together). For the Tergotometer experiments, one mixes at least three swatches which were equally stained.

After the washing step, a hand rinse step is carried out of 5 minute. Cloths were dried in the oven at 70° C. for 2 h or left dry overnight at room temperature.

The wash performance evaluation is carried out with a spectrophotometer (Hunterlab, Colorquest XE). Intensity and color measurements (CIE L*, a* and b* values) were taken before and after the wash and soil removal percentage was calculated using as control an unsoiled cotton swatch, according to the following equation:

Perf=SQRT{[L*aw−L*bw)²+(a*aw−a*bw)²+(b*aw−b*bw)²]/[(L*bw−L*w)²+(a*bw−a*w)²+(b*bw−b*w)²]}

Different test experiments are performed in order to assess the performances of the cosurfactant and/or soil release polymers on the commercial laundry formulations:

1. Primary Detergency:

a) Performance Vs. Detergent Concentration:

different dosages of commercial detergent are tested and the wash performances are measured for each dosage as indicated in the previous section. Typically the recommended dosage (2 g/L, 100% DETERGENT) as well as a reduced dosage (1.6 g/L, 80% DETERGENT) are performed. By doing this one quantifies the sensitivity of a given commercial formulation to a dosage variation.

b) Performance Vs. Additive(s).

The additives, typically the cosurfactant and/or the soil release polymer, are introduced on top of the recommended dosage (100% DETERGENT) and/or on top of the reduced dosage (80% DETERGENT). Typically 2 wt % active of additive are introduced on top op 100% DETERGENT, and 1.6% and 1.0% active on top of 80% DETERGENT.

2. Soil Release Performance:

In some cases, soil release experiments have been carried out on Cotton/polyester and Polyesters fabrics with Violet Dye in soy oil, Dirty Motor Oil and Lipstick in Mineral oil as stains. The evaluation of soil release tests are carried out by measuring the amount of soil removed with cloths pre-treated with laundry detergent (100% DETERGENT as well as 80% DETERGENT with or without additive). The additives are introduced in the wash together with the powder detergent. The overall performances are compared to laundry detergent art a 100% dosage. For the soil release tests, several swatches per pot are used. Pre-treatment washes are done using hard water (250 ppm) with calcium to magnesium ratio of 6:4. Water temperature was maintained at 30° C. and washing time set to 20 min in the case of a wash in the Tergotometer. If the wash is performed in the launderometer the washing time is fixed to 30 min. Cloths are dried in the oven at 70° C. for 2 hours or left overnight at room temperature followed by staining. After staining a secondary wash was done following the experimental procedure described in this section before.

3. Anti-Graying Experiments:

In some cases anti-graying experiments have been carried out in order to assess the anti-redeposition properties of the additives. The additives are introduced in the wash together with the powder detergent. The experiment consists of measuring the whiteness evolution of 6 white swatches (2 white swatches in cotton, 2 white swatches in cotton-polyester (50/50) and 2 swatches in polyester) when these are successively washed with 2 swatches containing dirt (1 prestained swatch in cotton with clay dirt (JB01) and 1 prestained swatch in cotton with sebum (JB03). At each wash, fresh prestained swatches are introduced and the “white” swatches are maintained to follow the evolution of the color. The tests are performed with hard water (250 ppm) with calcium to magnesium ratio of 6:4 at a temperature of 30° C. The washing cycle is set to 30 min in the launderometer. After each wash “white” cloths are dried and the L* value (lightness) of the fabrics are recorded with a spectrophotometer. These experiments can also be referred to as “ANTI-REDEPOSITION” experiments.

Tests and results are provided in the tables below. Amounts for additives are provided as active matter, compared to amount of amount of Detergent “C” indicates a comparative example.

| | TYPE OF EXPERIMENT | | | | | | |
|---|---|---|---|---|---|---|---|
| | PRIMARY DETERGENCY | | | | | | |
| Example | 1C | 2C | 3C | 4 | 5C | 6 | 7 |
| Type of Machine | Launderometer | | | | | | |
| Detergent | X-TRA ® | X-TRA ® | X-TRA ® | X-TRA ® | X-TRA ® | X-TRA ® | X-TRA ® |
| Dosage* | 100% | 80% | 100% | 100% | 80% | 80% | 80% |
| Additive 1: | / | / | / | DVAP-09- | / | DVAP-09- | DVAP-09- |
| | | | | QB01—2% | | QB01—1.6 | QB01—1.0 |
| | | | | active | | wt % active | wt % active |
| Additive 2: | / | / | Rhodasurf LA9 | / | Rhodasurf LA9 | / | / |
| | | | 2 wt % | | 1.6 wt % | | |
| Swatches | JB01/JB02/ | JB01/JB02/ | JB01/JB02/ | JB01/JB02/ | JB01/JB02/ | JB01/JB02/ | JB01/JB02/ |
| | JB03/VDC/ | JB03/VDC/ | JB03/VDC/ | JB03/VDC/ | JB03/VDC/ | JB03/VDC/ | JB03/VDC/ |
| | DMOC/LMC/ | DMOC/LMC/ | DMOC/LMC/ | DMOC/LMC/ | DMOC/LMC/ | DMOC/LMC/ | DMOC/LMC/ |
| | 20C/20D/ | 20C/20D/ | 20C/20D/ | 20C/20D/ | 20C/20D/ | 20C/20D/ | 20C/20D/ |
| | CS-61/LWFK | CS-61/LWFK | CS-61/LWFK | CS-61/LWFK | CS-61/LWFK | CS-61/LWFK | CS-61/LWFK |
| Maximum theoretical | 1000 | 1000 | 1000 | 1000 | 1000 | 1000 | 1000 |
| removal | | | | | | | |
| Primary detergency (% | 252 | 188 | 304 | 344 | 257 | 291 | 289 |
| removal) | | | | | | | |
| Primary detergency/ | 0.25 | 0.19 | 0.304 | 0.344 | 0.26 | 0.29 | 0.29 |
| Maximum amount | | | | | | | |
| Soil Release | / | / | / | / | / | / | |

*100% corresponds to 2 g/L

| | TYPE OF EXPERIMENT | | | | | | |
|---|---|---|---|---|---|---|---|
| | PRIMARY DETERGENCY | | | | | | |
| Example | 8C | 9C | 10C | 11 | 12C | 13 | 14 |
| Type of Machine | Launderometer | | | | | | |
| Detergent | YPE ® | YPE ® | YPE ® | YPE ® | YPE ® | YPE ® | YPE ® |
| Dosage* | 100% | 80% | 100% | 100% | 80% | 80% | 80% |
| Additive 1: | / | / | / | DVAP-09- | / | DVAP-09- | DVAP-09- |
| | | | | QB01—2% | | QB01—1.6 | QB01—1.0 |
| | | | | active | | wt % active | wt % active |
| Additive 2: | / | / | Rhodasurf LA9 | / | Rhodasurf LA9 | / | / |
| | | | 2 wt % | | 1.6 wt % | | |
| Swatches | JB01/JB02/ | JB01/JB02/ | JB01/JB02/ | JB01/JB02/ | JB01/JB02/ | JB01/JB02/ | JB01/JB02/ |
| | JB03/VDC/ | JB03/VDC/ | JB03/VDC/ | JB03/VDC/ | JB03/VDC/ | JB03/VDC/ | JB03/VDC/ |
| | DMOC/LMC/ | DMOC/LMC/ | DMOC/LMC/ | DMOC/LMC/ | DMOC/LMC/ | DMOC/LMC/ | DMOC/LMC/ |
| | 20C/20D/ | 20C/20D/ | 20C/20D/ | 20C/20D/ | 20C/20D/ | 20C/20D/ | 20C/20D/ |
| | CS-61/LWFK | CS-61/LWFK | CS-61/LWFK | CS-61/LWFK | CS-61/LWFK | CS-61/LWFK | CS-61/LWFK |
| Maximum theoretical | 1000 | 1000 | 1000 | 1000 | 1000 | 1000 | 1000 |
| removal | | | | | | | |
| Primary detergency (% | 325 | 269 | 370 | 408 | 331 | 346 | 342 |
| removal) | | | | | | | |
| Primary detergency/ | 0.32 | 0.27 | 0.37 | 0.41 | 0.33 | 0.35 | 0.34 |
| Maximum amount | | | | | | | |
| Soil Release | / | / | / | / | / | / | |

*100% corresponds to 2 g/L

| | TYPE OF EXPERIMENT | | | | | | |
|---|---|---|---|---|---|---|---|
| | PRIMARY DETERGENCY | | | | | | |
| Example | 15C | 16C | 17C | 18 | 19C | 20 | 21 |
| Type of Machine | Launderometer | | | | | | |
| Detergent | BLANC-O2 ® | BLANC-O2 ® | BLANC-O2 ® | BLANC-O2 ® | BLANC-O2 ® | BLANC-O2 ® | BLANC-O2 ® |
| Dosage* | 100% | 80% | 100% | 100% | 80% | 80% | 80% |
| Additive 1: | / | / | / | DVAP-09- | / | DVAP-09- | DVAP-09- |
| DVAP-09-QB01 | | | | QB01—2% | | QB01—1.6 | QB01—1.0 |
| | | | | active | | wt % active | wt % active |
| Additive 2: | / | / | Rhodasurf LA9 | / | Rhodasurf LA9 | / | / |
| (cosurfactant) | | | 2 wt % | | 1.6 wt % | | |
| Rhodasurf LA9 | | | | | | | |
| Swatches | JB01/JB02/ | JB01/JB02/ | JB01/JB02/ | JB01/JB02/ | JB01/JB02/ | JB01/JB02/ | JB01/JB02/ |
| | JB03/VDC/ | JB03/VDC/ | JB03/VDC/ | JB03/VDC/ | JB03/VDC/ | JB03/VDC/ | JB03/VDC/ |
| | DMOC/LMC/ | DMOC/LMC/ | DMOC/LMC/ | DMOC/LMC/ | DMOC/LMC/ | DMOC/LMC/ | DMOC/LMC/ |
| | 20C/20D/ | 20C/20D/ | 20C/20D/ | 20C/20D/ | 20C/20D/ | 20C/20D/ | 20C/20D/ |
| | CS-61/LWFK | CS-61/LWFK | CS-61/LWFK | CS-61/LWFK | CS-61/LWFK | CS-61/LWFK | CS-61/LWFK |
| Maximum theoretical | 1000 | 1000 | 1000 | 1000 | 1000 | 1000 | 1000 |
| removal | | | | | | | |
| Primary detergency (% | 222 | 178 | 273 | 312 | 236 | 269 | 271 |
| removal) | | | | | | | |
| Primary detergency/ | 0.22 | 0.18 | 0.27 | 0.31 | 0.24 | 0.27 | 0.27 |
| Maximum amount | | | | | | | |

*100% corresponds to 2 g/L

| | TYPE OF EXPERIMENT | | | | | | |
|---|---|---|---|---|---|---|---|
| | PRIMARY DETERGENCY | | | | | | |
| Example | 22C | 23C | 24C | 25 | 26C | 27 | 28 |
| Type of Machine | Launderometer | | | | | | |
| Detergent | LIBY ® | LIBY ® | LIBY ® | LIBY ® | LIBY ® | LIBY ® | LIBY ® |
| Dosage* | 100% | 80% | 100% | 100% | 80% | 80% | 80% |
| Additive 1: | / | / | / | DVAP-09- | / | DVAP-09- | DVAP-09- |
| | | | | QB01—2% | | QB01—1.6 | QB01—1.0 |
| | | | | active | | wt % active | wt % active |
| Additive 2: | / | / | Rhodasurf LA9 | / | Rhodasurf LA9 | / | / |
| | | | 2 wt % | | 1.6 wt % | | |
| Swatches | JB01/JB02/ | JB01/JB02/ | JB01/JB02/ | JB01/JB02/ | JB01/JB02/ | JB01/JB02/ | JB01/JB02/ |
| | JB03/VDC/ | JB03/VDC/ | JB03/VDC/ | JB03/VDC/ | JB03/VDC/ | JB03/VDC/ | JB03/VDC/ |
| | DMOC/LMC/ | DMOC/LMC/ | DMOC/LMC/ | DMOC/LMC/ | DMOC/LMC/ | DMOC/LMC/ | DMOC/LMC/ |
| Maximum theoretical | 600 | 600 | 600 | 600 | 600 | 600 | 600 |
| removal | | | | | | | |
| Primary detergency (% | 146 | 134 | 141 | 142 | 136 | 146 | 146 |
| removal) | | | | | | | |
| Primary detergency/ | 0.243 | 0.223 | 0.235 | 0.236 | 0.226 | 0.243 | 0.243 |
| Maximum amount | | | | | | | |
| Soil Release | / | / | / | / | / | / | |

*100% corresponds to 2 g/L

| | TYPE OF EXPERIMENT | | | | | |
|---|---|---|---|---|---|---|
| | PRIMARY DETERGENCY | | | | | |
| Example | 29C | 30C | 31C | 32 | 33C | 34 |
| Type of Machine | Launderometer | | | | | |
| Detergent | NICE ® | NICE ® | NICE ® | NICE ® | NICE ® | NICE ® |
| Dosage* | 100% | 80% | 100% | 100% | 80% | 80% |
| Additive 1: | / | / | / | DVAP-09- | / | DVAP-09- |
| | | | | QB01—2% | | QB01—1.0 |
| | | | | active | | wt % active |
| Additive 2: | / | / | Rhodasurf LA9 | / | Rhodasurf LA9 | / |
| | | | 2 wt % | | 1.6 wt % | |
| Swatches | JB01/JB02/ | JB01/JB02/ | JB01/JB02/ | JB01/JB02/ | JB01/JB02/ | JB01/JB02/ |
| | JB03 | JB03 | JB03 | JB03 | JB03 | JB03 |
| Maximum theoretical | 300 | 300 | 300 | 300 | 300 | 300 |
| removal | | | | | | |
| Primary detergency (% | 82.7 | 77.3 | 96.4 | 95.4 | 83.8 | 86 |
| removal) | | | | | | |
| Primary detergency/ | 0.275 | 0.257 | 0.321 | 0.318 | 0.279 | 0.286 |
| Maximum amount | | | | | | |

*100% corresponds to 2 g/L

| TYPE OF | PRIMARY DETERGENCY | | | |
|---|---|---|---|---|
| EXPERIMENT | | | | |
| Example | 35C | 36C | 37C | 38 |
| Type of Machine | Launderometer | | | |
| Detergent | FAB ® | FAB ® | FAB ® | FAB ® |
| Dosage* | 100% | 80% | 60% | 80% |
| Additive 1: | / | / | / | DVAP-09-QB01 - 1% |
| | | | | active |
| | / | / | | / |
| Swatches | JB01/JB02/JB03/VDC/DMOC/ | JB01/JB02/JB03/VDC/DMOC/ | JB01/JB02/JB03/VDC/DMOC/ | JB01/JB02/JB03/VDC/ |
| | LMC/CC/ | LMC/CC/ | LMC/CC/ | DMOC/LMC/CC/ |
| Maximum theoretical | 700 | 700 | 700 | 700 |
| removal | | | | |
| Primary detergency (% | 340 | 307 | 260.5 | 323 |
| removal) | | | | |
| Primary detergency/ | 0.485 | 0.438 | 0.372 | 0.461 |
| Maximum amount | | | | |

*100% corresponds to 1 g/L

| TYPE OF | SECONDARY OR SOIL RELEASE PERFORMANCE | | | |
|---|---|---|---|---|
| EXPERIMENT | | | | |
| Example | 35C | 36 | 37 | 38 |
| Type of Machine | Launderometer | | | |
| Detergent | FAB ® | FAB ® | FAB ® | FAB ® |
| Dosage* | 100% | 80% | 80% | 80% |
| Additive 1: | / | DVAP-09-QB01 - 1% | DVAP-09-QB01 - 2% | DVAP-09-QB01 - |
| DVAP-09-QB01 | | active | active | 5% active |
| | / | / | | / |
| Swatches | VDC/DMOC/LMC | VDC/DMOC/LMC/ | VDC/DMOC/LMC/ | VDC/DMOC/LMC/ |
| Maximum theoretical | 300 | 300 | 300 | 300 |
| removal | | | | |
| Primary detergency (% | | | | |
| removal) | | | | |
| Primary detergency/ | | | | |
| Maximum amount | | | | |
| Soil Release | 70.2 | 74.1 | 103.1 | 239.5 |
| Soil Release/ | 0.234 | 0.247 | 0.343 | 0.799 |
| Maximum amount | | | | |

*100% corresponds to 1 g/L

| TYPE OF | SECONDARY OR SOIL RELEASE PERFORMANCE | | | |
|---|---|---|---|---|
| EXPERIMENT | | | | |
| Example | 39C | 40 | 41 | 42 |
| Type of Machine | Launderometer | | | |
| Detergent | LIBY ® | LIBY ® | LIBY ® | LIBY ® |
| Dosage* | 100% | 80% | 80% | 80% |
| Additive 1: | / | DVAP-09-QB01 - 1% | DVAP-09-QB01 - 2% | DVAP-09-QB01 - |
| | | active | active | 5% active |
| | / | / | | / |
| Swatches | VDC/DMOC/LMC/ | VDC/DMOC/LMC/ | VDC/DMOC/LMC | VDC/DMOC/LMC |
| Maximum theoretical | 300 | 300 | 300 | 300 |
| removal | | | | |
| Primary detergency (% | | | | |
| removal) | | | | |
| Primary detergency/ | | | | |
| Maximum amount | | | | |
| Soil Release | 82.74 | 126 | 136.5 | 255.3 |
| Soil Release/ | 0.276 | 0.42 | 0.455 | 0.851 |
| Maximum amount | | | | |

*100% corresponds to 1 g/L

| | TYPE OF EXPERIMENT | | | | | | | |
|---|---|---|---|---|---|---|---|---|
| | PRIMARY DETERGENCY & SECONDARY OR SOIL RELEASE PERFORMANCE | | | | | | | |
| Example | 43C | 44C | 45 | 46 | 47C | 48 | 49C | 50 |
| Type of Machine | Launderometer | | | | | | | |
| Detergent | NICE ® | NICE ® | NICE ® | NICE ® | NICE ® | NICE ® | NICE ® | NICE ® |
| Dosage* | 100% | 80% | 80% | 80% | 100% | 80% | 100% | 80% |
| Additive 1: | / | / | DVAP-08- | DVAP-08- | / | DVAP-08- | / | DVAP-08- |
| | | | 6B01—1% | 6B02—1% | | 6B01—1% | | 6B01—1% |
| | | | active | active | | active | | active |
| | / | / | | / | | | | |
| Swatches | JB01/JB02/ | JB01/JB02/ | JB01/JB02/ | JB01/JB02/ | VDPE/ | VDPE/ | VDCPE/ | VDCPE/ |
| | JB03 | JB03 | JB03 | JB03 | DMOPE | DMOPE | DMOCPE | DMOCPE |
| Maximum theoretical | 300 | 300 | 300 | 300 | 200 | 200 | 200 | 200 |
| removal | | | | | | | | |
| Primary detergency (% | 160 | 140.4 | 159 | 153.5 | | | | |
| removal) | | | | | | | | |
| Primary detergency/ | 0.533 | 0.468 | 0.53 | 0.511 | | | | |
| Maximum amount | | | | | | | | |
| Soil Release | | | | | 34.75 | 67.65 | 67.5 | 78.46 |
| Soil Release/ | | | | | 0.173 | 0.338 | 0.337 | 0.392 |
| Maximum amount | | | | | | | | |

*100% corresponds to 2 g/L

| | TYPE OF EXPERIMENT | | | | | |
|---|---|---|---|---|---|---|
| | PRIMARY DETERGENCY | | | | | |
| Example | 51C | 52C | 53C | 54C | 55 | 56 |
| Type of Machine | Tergotometer | | | | | |
| Detergent | NICE ® | NICE ® | NICE ® | NICE ® | NICE ® | NICE ® |
| Dosage* | 100% | 80% | 80% | 80% | 80% | 80% |
| Additive 1: | / | / | / | ROT SRP6—1% | / | / |
| Additive 2: | / | / | BET C30—1% | / | / | / |
| Additive 3: | / | / | / | / | BET C30—0.5% | BET C30—0.75% |
| Additive 4: | / | / | / | / | ROT SRP6—0.5% | ROT SRP6—0.25% |
| Swatches | JB01/JB02/ | JB01/JB02/ | JB01/JB02/ | JB01/JB02/ | JB01/JB02/ | JB01/JB02/ |
| | JB03/VDC/ | JB03/VDC/ | JB03/VDC/ | JB03/VDC/ | JB03/VDC/ | JB03/VDC/ |
| | DMOC/BMI | DMOC/BMI | DMOC/BMI | DMOC/BMI | DMOC/BMI | DMOC/BMI |
| Maximum theoretical | 600 | 600 | 600 | 600 | 600 | 600 |
| removal | | | | | | |
| Primary detergency (% | 280 | 251 | 277 | 264 | 279 | 308 |
| removal) | | | | | | |
| Primary detergency/ | 0.466 | 0.418 | 0.461 | 0.44 | 0.465 | 0.513 |
| Maximum amount | | | | | | |

*100% corresponds to 2 g/L

| TYPE OF EXPERIMENT | SECONDARY OR SOIL RELEASE PERFORMANCE | | | |
|---|---|---|---|---|
| Example | 57C | 58C | 59 | 60 |
| Type of Machine | Tergotometer | | | |
| Detergent | NICE ® | NICE ® | NICE ® | NICE ® |
| Dosage* | 100% | 80% | 80% | 80% |
| Additive 1: | / | ROT SRP6 - | / | / |
| | | 1% | | |
| Additive 2: | / | / | / | / |
| Additive 3: | / | / | DVAP-08-6C01 | / |
| | | | 1% | |
| Additive 4: | / | / | / | DVAP-08-6C02 |
| | | | | 1% |
| Swatches | VDPE/DMOPE/ | VDPE/DMOPE/ | VDPE/DMOPE/ | VDPE/DMOPE/VDCPE/ |
| | VDCPE/CMOCPE | VDCPE/CMOCPE | VDCPE/CMOCPE | CMOCPE |
| Maximum theoretical | 400 | 400 | 400 | 400 |
| removal | | | | |
| Soil Release (% removal) | 148 | 216 | 181.5 | 164.7 |
| Soil Release/Maximum | 0.37 | 0.54 | 0.453 | 0.411 |
| amount | | | | |

*100% corresponds to 2 g/L

| | TYPE OF EXPERIMENT | | | | | |
|---|---|---|---|---|---|---|
| | PRIMARY DETERGENCY | | | | | |
| Example | 61C | 62C | 63C | 64C | 65 | 66 |
| Type of Machine | Tergotometer | | | | | |
| Detergent | LIBY ® | LIBY ® | LIBY ® | LIBY ® | LIBY ® | LIBY ® |
| Dosage* | 100% | 80% | 80% | 80% | 80% | 80% |
| Additive 1: | / | / | / | ROT SRP6—1% | / | / |
| Additive 2: | / | / | BET C30—1% | / | / | / |
| Additive 3: | / | / | / | / | DVAP-08- | / |
| | | | | | 6C01 1% | |
| Additive 4: | / | / | / | / | / | DVAP-08- |
| | | | | | | 6C02 1% |
| Swatches | JB01/JB02/ | JB01/JB02/ | JB01/JB02/ | JB01/JB02/ | JB01/JB02/ | JB01/JB02/ |
| | JB03/ | JB03/ | JB03/ | JB03/ | JB03/ | JB03/ |
| Maximum theoretical | 300 | 300 | 300 | 300 | 300 | 300 |
| removal | | | | | | |
| Primary detergency (% | 188.4 | 172.6 | 176.5 | 178.7 | 176.2 | 175.8 |
| removal) | | | | | | |
| Primary detergency/ | 0.628 | 0.575 | 0.588 | 0.595 | 0.587 | 0.586 |
| Maximum amount | | | | | | |

*100% corresponds to 2 g/L

| TYPE OF EXPERIMENT | SECONDARY OR SOIL RELEASE PERFORMANCE | | | |
|---|---|---|---|---|
| Example | 67C | 68C | 69 | 70 |
| Type of Machine | Tergotometer | | | |
| Detergent | LIBY ® | LIBY ® | LIBY ® | LIBY ® |
| Dosage* | 100% | 80% | 80% | 80% |
| Additive 1: | / | ROT SRP6 - | / | / |
| (SRP) - Amount** | | 1% | | |
| Additive 2: | / | / | / | / |
| (cosurfactant)—Amount* | | | | |
| Additive 3: | / | / | DVAP-08-6C01 | / |
| DVAP-08-6C01 | | | 1% | |
| Additive 4: | / | / | / | DVAP-08-6C02 |
| DVAP-08-6C02 | | | | 1% |
| Swatches | VDPE/DMOPE/ | VDPE/DMOPE/ | VDPE/DMOPE/ | VDPE/DMOPE/VDCPE/ |
| | VDCPE/CMOCPE | VDCPE/CMOCPE | VDCPE/CMOCPE | CMOCPE |
| Maximum theoretical | 400 | 400 | 400 | 400 |
| removal | | | | |
| Soil Release (% removal) | 153.9 | 261.5 | 222 | 127.6 |
| Soil Release/Maximum | 0.384 | 0.653 | 0.555 | 0.319 |
| amount | | | | |

*100% corresponds to 2 g/L

| | TYPE OF EXPERIMENT | | | | | | |
|---|---|---|---|---|---|---|---|
| | SECONDARY OR SOIL RELEASE PERFORMANCE | | | | | | |
| Example | 71C | 72C | 73C | 74 | 75 | 76 | 77 |
| Type of Machine | Tergotometer | | | | | | |
| Detergent | NICE ® | NICE ® | NICE ® | NICE ® | NICE ® | NICE ® | NICE ® |
| Dosage* | 100% | 80% | 80% | 80% | 80% | 80% | 80% |
| Additive 1: | / | ROT SRP6—1% | / | / | / | / | / |
| Additive 2: | / | / | ROT SF2—1%/ | / | / | / | / |
| Additive 3: | / | / | | DVAP-08- | / | / | / |
| | | | | 6C01 1%/ | | | |
| Additive 4: | / | / | / | / | DVAP-08- | / | / |
| | | | | | 6C02 1% | | |
| Additive 5: | / | / | / | / | / | DVAP-08- | / |
| | | | | | | 2C01 1% | |
| Additive 6: | / | / | / | / | / | / | DVAP-08- |
| | | | | | | | 2C02 1% |
| Swatches | VDPE/ | VDPE/ | VDPE/ | VDPE/ | VDPE/ | VDPE/ | VDPE/ |
| | DMOPE/ | DMOPE/ | DMOPE/ | DMOPE/ | DMOPE/ | DMOPE/ | DMOPE/ |
| | VDCPE/ | VDCPE/ | VDCPE/ | VDCPE/ | VDCPE/ | VDCPE/ | VDCPE/ |
| | CMOCPE | CMOCPE | CMOCPE | CMOCPE | CMOCPE | CMOCPE | CMOCPE |
| Maximum theoretical | 400 | 400 | 400 | 400 | 400 | 400 | 400 |
| removal | | | | | | | |
| Soil Release (% | 147.7 | 215.15 | 322.58 | 181.26 | 161.86 | 324.77 | 315.7 |
| removal) | | | | | | | |
| Soil Release/ | 0.369 | 0.537 | 0.806 | 0.453 | 0.404 | 0.811 | 0.789 |
| Maximum amount | | | | | | | |

*100% corresponds to 2 g/L

| TYPE OF | PRIMARY DETERGENCY | | | | |
|---|---|---|---|---|---|
| EXPERIMENT | | | | | |
| Example | 78C | 79C | 80C | 81 | 82 |
| Type of Machine | Tergotometer | | | | |
| Detergent | NICE ® | NICE ® | NICE ® | NICE ® | NICE ® |
| Dosage* | 100% | 80% | 80% | 80% | 80% |
| Additive 1: | / | BET C30 - 1% | / | / | / |
| Additive 2: | / | / | DCG - 1%/ | / | / |
| Additive 3: | / | / | / | DVAP-08-6DC01 - | / |
| | | | | 1% | |
| Additive 4: | / | / | / | / | DVAP-08-6DC02 - |
| | | | | | 1% |
| Swatches | JB01/JB02/JB03/ | JB01/JB02/JB03/ | JB01/JB02/JB03/ | JB01/JB02/JB03/ | JB01/JB02/JB03/ |
| | VDC/DMOC/VDPE/ | VDC/DMOC/VDPE/ | VDC/DMOC/VDPE/ | VDC/DMOC/VDPE/ | VDC/DMOC/VDPE/ |
| | DMOPE/VDCPE/ | DMOPE/VDCPE/ | DMOPE/VDCPE/ | DMOPE/VDCPE/ | DMOPE/VDCPE/ |
| | DMOCPE | DMOCPE | DMOCPE | DMOCPE | DMOCPE |
| Maximum theoretical | 900 | 900 | 900 | 900 | 900 |
| removal | | | | | |
| Primary detergency (% | 446.41 | 441.10 | 435.77 | 447.71 | 435.54 |
| removal) | | | | | |
| Primary detergency/ | 0.496 | 0.490 | 0.483 | 0.497 | 0.484 |
| Maximum amount | | | | | |

*100% corresponds to 2 g/L

| TYPE OF | PRIMARY DETERGENCY | | | | |
|---|---|---|---|---|---|
| EXPERIMENT | | | | | |
| Example | 83C | 84C | 85C | 86 | 87 |
| Type of Machine | Tergotometer | | | | |
| Detergent | LIBY ® | LIBY ® | LIBY ® | LIBY ® | LIBY ® |
| Dosage* | 100% | 80% | 80% | 80% | 80% |
| Additive 1: | / | BET C30 - 1% | / | / | / |
| Additive 2: | / | / | DCG - 1%/ | / | / |
| Additive 3: | / | / | / | DVAP-08-6DC01 - | / |
| | | | | 1% | |
| Additive 4: | / | / | / | / | DVAP-08-6DC02 - |
| | | | | | 1% |
| Swatches | JB01/JB02/JB03/ | JB01/JB02/JB03/ | JB01/JB02/JB03/ | JB01/JB02/JB03/ | JB01/JB02/JB03/ |
| | VDC/DMOC/VDPE/ | VDC/DMOC/VDPE/ | VDC/DMOC/VDPE/ | VDC/DMOC/VDPE/ | VDC/DMOC/VDPE/ |
| | DMOPE/VDCPE/ | DMOPE/VDCPE/ | DMOPE/VDCPE/ | DMOPE/VDCPE/ | DMOPE/VDCPE/ |
| | DMOCPE | DMOCPE | DMOCPE | DMOCPE | DMOCPE |
| Maximum theoretical | 900 | 900 | 900 | 900 | 900 |
| removal | | | | | |
| Primary detergency (% | 512.05 | 504.41 | 510.47 | 509.12 | 510.94 |
| removal) | | | | | |
| Primary detergency/ | 0.569 | 0.560 | 0.567 | 0.565 | 0.567 |
| Maximum amount | | | | | |

*100% corresponds to 2 g/L

| | TYPE OF EXPERIMENT | | | | | | | | | | | |
|---|---|---|---|---|---|---|---|---|---|---|---|---|
| | ANTI GRAYING EXPERIMENT | | | | | | | | | | | |
| Example | 88C | | | 89C | | | 90 | | | 91C | | |
| Type of Machine | Launderometer | | | | | | | | | | | |
| Detergent | X-TRA ® | | | X-TRA ® | | | X-TRA ® | | | X-TRA ® | | |
| Dosage* | 100% | | | 80% | | | 80% | | | 80% | | |
| Additive 1: | / | | | / | | | DVAP-09- | | | / | | |
| DVAP-09-QB01 | | | | | | | QB01 1% | | | | | |
| Additive 2: | / | | | / | | | / | | | Rhodasurf LA9 | | |
| Rhodasurf LA9 | | | | | | | | | | 1% | | |
| Swatches | C | CPE | PE | C | CPE | PE | C | CPE | PE | C | CPE | PE |
| Performance @ Wash 0 | 84.14 | 89.43 | 85.41 | 84.43 | 89.515 | 85.45 | 84.49 | 89.525 | 85.55 | 84.28 | 89.54 | 85.43 |
| Performance @ Wash 1 | 85.97 | 85.97 | 79.60 | 85.70 | 83.75 | 75.76 | 86.14 | 86.955 | 81.645 | 85.76 | 88.085 | 81.985 |
| Performance @ Wash 2 | 86.35 | 79.93 | 68.68 | 85.82 | 76.915 | 65.145 | 86.71 | 86.305 | 81.415 | 86.62 | 86.24 | 78.265 |
| Performance @ Wash 3 | | | | | | | | | | | | |
| Performance @ Wash 4 | 86.35 | 73.84 | 63.21 | 85.75 | 70.01 | 57.205 | 87.26 | 86.185 | 81.475 | 86.9 | 82.51 | 69.68 |
| Performance @ Wash 5 | 85.94 | 70.125 | 59.5 | 85.60 | 66.54 | 52.27 | 87.17 | 85.59 | 81.855 | 86.74 | 79.255 | 64.80 |
| Performance @ Wash 6 | 85.57 | 65.725 | 49.90 | 84.30 | 62.99 | 48.175 | 87.13 | 84.595 | 82.005 | 86.67 | 77.65 | 60.62 |
| Performance @ Wash 7 | 85.46 | 64.63 | 48.13 | 84.54 | 62.145 | 47.04 | 87.12 | 84.265 | 82.16 | 86.72 | 77.21 | 59.655 |
| Performance @ Wash 8 | 85.03 | 65.105 | 47.95 | 84.03 | 61.315 | 45.39 | 87.025 | 83.92 | 82.515 | 86.64 | 75.85 | 56.175 |

1. Use in a laundry composition comprising surfactant(s), as agents improving primary detergency, secondary detergency, and/or soil anti-redeposition and/or a as agent allowing a reduction of the amount of surfactant(s) and/or of builder(s), of a performance association of the following compounds:
a) a polyester soil-release polymer, and
b) a cosurfactant.

2. Use according to claim 1, wherein the laundry composition is in the form of a powder, granules, tablets, or a liquid.

3. Use according to claim 1, wherein the laundry composition is diluted with water during a process of washing to a concentration such that the amount of compound a) is of lower than 0.1 g/L, preferably of lower than 0.02 g/L, preferably of lower than 0.01 g/L, preferably of lower than or equal to 0.005 g/L.

4. Use according to claim 1, wherein compound a) is a non ionic polyethylene terephthalate/polyoxyethylene terephthalate copolyester.

5. Use according to claim 1 wherein compound b) is selected from the group consisting of the following:
fatty alcohols polyalkoxylates, with the fatty alcohol being preferably a C₁₄-C₁₈ fatty alcohol and/or with the polyalkoxylate being preferably a C₁₅-C₂₅
terpene alkoxylates, for example ethoxylated and/or propoxylated terpenes,
betaines, preferably alkylbetaines alkylamidoalkyl betai<'>nes, preferably an alkylamidopropyl betaine, wherein the alkyl is preferably a C₁₂-C₁₄ alkyl, sultaines, preferably alkylamidoalkyl sultai<'>nes, preferably an alkylamidopropyl sultaine or hydroxysultaine, wherein the alkyl is preferably a C₁₂-C₁₄ alkyl
anionic gemmi anionic surfactants, preferably gemini surfactants having two carboxylic moieties.

6. Use according to claim 1, wherein the amount of compound a) in the laundry composition is of lower than 1% by weight, preferably of lower than or equal to 0.5% by weight, preferably of lower than or equal to 0.25% by weight.

7. Use according to claim 1 wherein the amount of compound b) in the laundry composition is of lower than 1% by weight, preferably of lower than or equal to 0.5% by weight, preferably of lower than or equal to 0.25% by weight.

8. A performance additive comprising:
at least 20% by weight as actives, preferably at least 30%, preferably at least 50%, preferably at least 75%, preferably a least 90%, of a mixture of the following compounds:
a) a polyester soil-release polymer
b) a cosurfactant, and
optionally water or other products, in a amount by weight if present of lower than 80%, preferably of lower than 70%, preferably of lower than 50%.

9. A performance additive according to claim 10, being in a solid form.

10. A performance additive according to claim 8, being in a liquid form, with an amount of actives being preferably of from 20% to 90% by weight, preferably of from 30 to 40%.

11. A performance additive according to claim 8, wherein compound a) is a non ionic polyethylene terephthalate/polyoxyethylene terephthalate copolyester.

12. A performance additive according to claim 8, wherein compound b) is selected from the group consisting of the following:
fatty alcohols polyalkoxylates, with the fatty alcohol being preferably a C₁₄-C₁₈ fatty alcohol and/or with the polyalkoxylate being preferably a C₁₅-C₂₅
terpene alkoxylates, for example ethoxylated and/or propoxylated terpenes,
betaines, preferably alkylbetaines alkylamidoalkyl betaines, preferably an alkylamidopropyl betaine, wherein the alkyl is preferably a C₁₂-C₁₄ alkyl, sultaines, preferably alkylamidoalkyl sultai<'>nes, preferably an alkylamidopropyl sultaine or hydroxysultaine, wherein the alkyl is preferably a C₁₂-C₁₄ alkyl
anionic gemini anionic surfactants, preferably gemini surfactants having two carboxylic moieties.

13. A performance additive according to claim 8, wherein the ratio by weight between compound b) and compound a) is of from 1/10 to 10/1, preferably of from 1/4 to 4/1, preferably of from 1/2 to 2/1.

14. A process of making a laundry composition, comprising the step of mixing a performance additive according to claim 8, with other ingredients.

15. A process according to claim 14, wherein from 0.1 to 10, preferably from 0.5 to 2 parts as solids of performance additive are mixed with from 80 to 100 parts of other ingredients.

16. A process according to claim 14, wherein mixing a performed during of after mixing other ingredients.

17. A process according to claim 14, wherein:
the laundry composition is in a powder form,
the performance additive is in a powder form, and
mixing of the performance additive is performed after mixing other ingredients.

18. A process according to claim 14, wherein:
the laundry composition is in a powder form,
the performance additive is in a liquid form, and
mixing of the performance additive is performed before obtaining the powder form, preferably at a slurry stage before atomization.

19. A process of washing textiles involving diluting a laundry composition as described in claim 1.

20. A process of washing textiles involving diluting a laundry composition as described in claim 14.
